(19) United States
(12) Patent Application Publication
(10) Pub. No.: US 2008/0309323 A1
(43) Pub. Date: Dec. 18, 2008

(54) METHOD FOR BIOCHEMICAL ANALYSIS

(75) Inventors: Kazuhisa Okano, Tokyo (JP); Takashi Ikeda, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/135,982

(22) Filed: Jun. 9, 2008

(30) Foreign Application Priority Data
Jun. 12, 2007 (JP) 2007-154992

(51) Int. Cl. G01N 27/74

(52) U.S. Cl. 324/204

(57) ABSTRACT

It is intended to provide a supersensitive, quick and accurate method for biochemical analysis. The method includes: adding magnetic fine particles into a solution containing a target substance, whereby a first substance for detection immobilized on the magnetic fine particle is bound to the target substance, while aggregating the magnetic fine particles so as to form an aggregate in the solution; next binding the target substance bound with the magnetic fine particle constituting the aggregate to a second substance for detection on a magnetic sensor layer so as to immobilize the aggregate onto the surface of the magnetic sensor layer; and measuring a magnetic stray field of this aggregate using a magnetic sensor.

### BACKGROUND OF THE INVENTION

1. Field of the Invention

The present invention relates to a method for biochemical analysis including immobilizing a target substance in a sample using magnetic fine particles and magnetically measuring this target substance. Particularly, the present invention relates to a method for biochemical analysis using specific chemical binding.

2. Description of the Related Art

Techniques using magnetic fine particles have been utilized as valuable tools in some fields of biotechnology. These techniques have the advantage that a magnetic fine particle-biomolecule complex is obtained by a biochemical reaction process in which magnetic fine particles are chemically attached or bound to various biomolecules (e.g., proteins and DNAs) having the ability to selectively recognize targets. To separate this complex, the complex is selectively captured by a magnetic field, and unnecessary impurities are removed. An alternative method for separating this complex includes confining the complex in a predetermined space by a magnetic field or forming an aggregate of the complex.

Detection methods including labeling a biomolecule as a target substance with fine particles using such specific binding of biomolecules include the following three methods:

(1) a method for optically detecting an aggregate of fine particles;
(2) a method for optically detecting an aggregate of magnetic fine particles; and
(3) a method for magnetically detecting magnetic fine particles.

These detection methods are applicable to uses including a wide variety of medical tests such as medical tests using a trace amount of a sample (e.g., blood) to be tested, home medical care and preventive medical care. Therefore, these detection methods have been expected to broaden their market reach to a wide variety of fields. Thus, performance such as supersensitivity, a quick test and a compact apparatus has been demanded for devices using these detection methods.

Hereinafter, the detection methods (1) to (3) will be described in more detail.

(1) Method for Optically Detecting an Aggregate of Fine Particles

In clinical fields, an immunonephelometry (a) has been well known as a conventional method for optically detecting an aggregate formed in a solution. However, it has been known that this immunonephelometry does not establish the linear proportional relationship between absorbance and a target substance concentration and gives a nonlinear calibration curve. Thus, the immunonephelometry involves: assuming functions having some parameters as calibration curves and determining the parameters in advance by experiments; and then applying actually measured absorbance to the calibration curves determined by experiments so as to measure a target substance concentration (absolute calibration curve method).

Alternatively, a measurement method more sensitive than the immunonephelometry is a measurement method using latex immunoagglutination reaction (latex immunoassay; hereinafter, referred to as “LIA”) (b). LIA uses a latex reagent in which an antibody against a target substance (antigen) to be measured is adsorbed on the surfaces of polystyrene latex fine particles (particle size: approximately 0.05 to 1 μm). If an antigen capable of reacting with this antibody is present in a sample, the concentration of the antigen is measured using a phenomenon in which the latex particles are aggregated through antigen-antibody reaction. LIA can increase detection sensitivity to 10 to 100 times that of immunonephelometry by using latex aggregation. Therefore, this measurement method is suitable for measuring a trace amount of a component.

The immunonephelometry (a) has low sensitivity, as described above. This is because an aggregate of immunonephelometry caused by the antigen-antibody reaction is very small and is difficult to optically detect in a low-concentration region having a small amount of an antigen. On the other hand, the LIA (b) has high sensitivity. This is because an antibody is bound to relatively large latex particles on a μm scale so as to form an aggregate. Therefore, antigen-antibody reaction takes an apparently large form such as latex aggregation. Specifically, in LIA, such antigen-immobilized latex particles form a large aggregate, and a slight change in the aggregate can be captured optically.

(2) Method for Optically Detecting an Aggregate of Magnetic Fine Particles

On the other hand, Japanese Patent Application Laid-Open No. H05-240859 proposes a method for optically detecting the dispersed state of magnetic fine particles by a method different from those described above. FIG. 2B illustrates a flow chart of procedures for measuring a target substance by the method of Japanese Patent Application Laid-Open No. H05-240859. As illustrated in FIG. 2B, this method includes: initially reacting a sample with magnetic fine particles bound with a secondary antibody capable of specifically binding to an antigen to be measured; then forcedly aggregating the magnetic fine particles bound with the antigen to be measured in a container by magnetic force so as to increase the concentration thereof; next releasing the magnetic fine particles with the thus-increased concentration from the state forcedly aggregated by magnetic force; and optically measuring the turbidity of the released magnetic fine particles in a dispersed state and the absorbance thereof.

This method uses magnetic fine particles. Therefore, a natural aggregate of the magnetic fine particles can be separated and removed effectively by a method such as the action of a magnetic field. As a result, a target substance with a low concentration can be detected.

(3) Method for Magnetically Detecting Magnetic Fine Particles

Alternatively, Biosensors and Bioelectronics, 2004, Vol. 19, p. 1149-1156 (hereinafter, referred to as Document 1) discloses a method including immobilizing magnetic fine particles onto a substrate having a GMR sensor (magnetic sensor) and magnetically detecting these magnetic fine particles. FIG. 2A illustrates a flow chart of procedures for measuring a target substance by the method of Document 1. As illustrated in FIG. 2A, the method described in this Document 1 includes: at a first stage, forming probe DNA (primary antibody) on a polymer formed on a GMR sensor; next, at a second stage, hybridizing DNA for analysis (target substance) labeled with biotin to the probe DNA through complementary reaction so as to immobilize the DNA for analysis onto the substrate; at a third stage, introducing streptavidin (secondary antibody)-coated magnetic fine particles so as to immobilize the magnetic fine particles onto the GMR sensor through specific avidin-biotin reaction; and then removing redundant DNA by washing and performing measurement by detecting a magnetic stray field of the magnetic fine particles using the GMR sensor.

This GMR sensor basically has a sandwich structure in which a nonmagnetic layer is sandwiched between two magnetic layers. An external magnetic field is detected depending on the relative magnetization directions (parallel/antiparallel) of these two magnetic layers. Specifically, this GMR sensor generally performs the detection of an external magnetic field by signal detection depending on the presence or absence of inversion of magnetization of the magnetic layers.

FIGS. 3A to 3C more specifically illustrate the method described in this Document 1. First, as illustrated in FIG. 3A, a primary antibody is immobilized onto a GMR sensor having an upper surface on which Au or a polymer is formed. Next, as illustrated in FIG. 3B, a solution containing an antigen as a target substance is added into a container having the formed GMR sensor so as to immobilize the antigen onto the primary antibody by specific binding through antigen-antibody reaction caused by the collision therebetween. This reaction is solid phase-liquid phase reaction occurring between the primary antibody on the substrate and the antigen in the solution.

Next, as illustrated in FIG. 3C, magnetic fine particles having a surface coated with a secondary antibody are added into the solution. As a result, the magnetic fine particles collide by a diffusion motion such as the Brownian motion with the antigen specifically bound with the primary antibody immobilized on the GMR sensor. In this procedure, the unreacted functional site of the antigen is specifically bound with the secondary antibody on the surface of the magnetic fine particle so as to immobilize the magnetic fine particles onto the GMR sensor. This reaction is solid phase-liquid phase reaction occurring between the antigen on the substrate and the magnetic fine particles in the solution. In this method, the magnetic fine particles are immobilized only on an area in which the antigen is present. Therefore, a magnetic stray field of the magnetic fine particles can be detected using the GMR sensor so as to quantify the amount of the antigen.

Such a magnetic sensor formed on a substrate, such as a GMR sensor, has the following advantages: immobilized magnetic fine particles can be positioned very close to a magnetic sensor so as to detect a magnetic stray field thereof with supersensitivity; a primary antibody-immobilized magnetic sensor can be prepared as an array using a micromachining process, and different substances to be detected can be measured simultaneously (multiple measurement); and a sensor module can be made compact.

Moreover, a highly sensitive sensor that can be formed on a substrate, other than a GMR sensor includes a TMR sensor and a Hall sensor. Furthermore, for example, SQUID, an AMR sensor, a magnetic impedance sensor and a fluxgate sensor are also applicable as long as a process capable of forming such a sensor on a substrate is established.

However, the a method for optically detecting an aggregate of fine particles (1), the method for optically detecting an aggregate of magnetic fine particles (2) and the method for magnetically detecting magnetic fine particles (3) had problems described below.

(1) A Method for Optically Detecting an Aggregate of Fine Particles

In the LIA, aggregation phenomenon is caused by non-specific binding between latex beads in addition to the aggregation reaction via specific binding to the target substance. Thus, it is difficult to distinguish the aggregates via the specific binding to the target substance from the aggregates caused by the non-specific binding. As a result, measurement is exceedingly difficult when the amount of the target substance contained in the sample is small.

Moreover, in LIA, the optically detectable change in sample solution caused by aggregation is measured (ex. absorbance). Thus, it is difficult to discriminate the kind of the target substance. Therefore, LIA have been used only when the target substance is a single kind. Furthermore, a light source and a photoreceiver used in the optical detection method are generally large apparatuses. Particularly, a particle counter or the like may be used for the purpose of enhancing sensitivity. In such as case, an apparatus was made larger, and a compact apparatus was difficult to achieve.

(2) Method for Optically Detecting an Aggregate of Magnetic Fine Particles

FIG. 4B illustrates a flow chart of measurement procedures in the method for optically detecting an aggregate of magnetic fine particles (2). As illustrated in FIG. 4B, this method includes: initially reacting a target substance to be measured with magnetic fine particles on which a secondary antibody capable of specifically binding to the target substance is immobilized; then forcedly aggregating the magnetic fine particles bound with the target substance in a container by magnetic force so as to increase the concentration thereof; next releasing the magnetic fine particles with the thus-increased concentration from the state forcedly aggregated by magnetic force; and optically measuring the turbidity of the released magnetic fine particles in a dispersed state and the absorbance thereof.

In this method, magnetic fine particles can be stirred in the sample solution by magnetic field from outside. Therefore, the method can increase the efficiency of aggregation reaction of magnetic fine particles.

However, this method involves optically measuring an aggregate of fine particles, as in the method (1). Therefore, it is difficult to quantitatively measure plural types of target substances in some cases. Furthermore, an apparatus necessary for the optical measurement is rendered large, and a compact apparatus was difficult to achieve.

Moreover, such magnetic fine particles have large magnetization such that they sometimes aggregate even without a magnetic field. When they aggregate, the surface area which can react with the target substance is reduced. In other words, the number of antibodies recognizing the target substance is reduced. Thus, there is a fear that the target substances do not react with the fine magnetic particles sufficiently.

Also, in some cases, when using fine magnetic particles having large magnetization, magneto static coupling is maintained even after the application of the magnetic field is discontinued. In such a case, it is difficult to re-disperse fine magnetic particles which do not bind to the target substance in the sample solution. As a result, the measurement of the target substance is difficult.

(3) Method for Magnetically Detecting Magnetic Fine Particles

FIG. 4A illustrates a flow chart of measurement procedures in the method for magnetically detecting magnetic fine particles (3). As illustrated in FIG. 4A, this method includes: initially specifically binding a sample (target substance) to a substance for detection (primary antibody) immobilized on the surface of a magnetic sensor; next immobilizing magnetic fine particles via a substance for detection (secondary antibody) onto the target substance specifically bound with this primary antibody; and finally measuring the magnetic fine particles immobilized on the magnetic sensor using the magnetic sensor.

This method is a so-called sandwich method, which uses highly dispersible magnetic fine particles. Therefore, the magnetic fine particles that are not specifically bound with the primary antibody and are unimmobilized on the substrate are removed at a later stage. Therefore, such magnetic fine particles are hardly detected using the magnetic sensor. Moreover, the magnetic fine particles are immobilized very close to the magnetic sensor on the substrate. Therefore, a highly sensitive biosensor with a low noise can be constructed.

However, this method, unlike the optical detection method, is based on the specific binding reaction between a solid phase and a liquid phase as follows: the reaction between the primary antibody on the magnetic sensor surface (solid phase) and the target substance (liquid phase); and the reaction between the target substance bound with the primary antibody on the magnetic sensor surface (solid phase) and the secondary antibody on the surface of the magnetic fine particle in the solution (liquid phase).

Moreover, collision frequency (reaction rate) of the molecules is extremely low in reaction between a solid phase and a liquid phase comparing to the reaction between a liquid phases and a liquid phase, because the specific binding reaction is formed by the collision between the immobilized molecule in the solid phase and the molecule in the liquid phase that is randomly moved in the solution. As a result, it takes extremely long until magnetic fine particles immobilize onto the sensor surface in saturated state.

In this method, as similar to the method for optically detecting an aggregate of magnetic fine particles, a target substance can be detected by applying a magnetic field to gather magnetic fine particles onto the surface of a sensor and then discontinuing the magnetic field to remove the magnetic fine particle which does not bind with the target substance. However, to avoid non-specific aggregation caused by magneto static coupling, magnetic fine particles with large magnetization cannot be used. Thus, the time to gather magnetic fine particles onto the surface of a sensor is not shortened sufficiently, although magnetic field application to magnetic fine particles is adopted as similar to the present invention.

### SUMMARY OF THE INVENTION

Thus, the present inventor has conducted diligent studies on the problems of the detection methods (1) to (3). The present inventor has consequently found that the reaction between a first substance for detection immobilized on magnetic fine particle surface and a target substance and the reaction between the target substance bound with the magnetic fine particle and a second substance for detection may be performed by specific binding through liquid phase-liquid phase reaction. The present inventor has also found that after the aggregation of these magnetic fine particles, this aggregate may be measured by a magnetic method. Specifically, an object of the present invention is to provide a supersensitive, quick and accurate method for biochemical analysis including conducting analysis by such procedures.

To attain the object, the present invention has characteristics described below.

1. A method for biochemical analysis comprising: (1) preparing magnetic fine particles having a surface on which a first substance for detection capable of binding to a target substance is immobilized; (2) preparing a magnetic sensor layer having a surface on which a second substance for detection capable of binding to the target substance is immobilized; (3) adding the magnetic fine particles into a solution containing the target substance, whereby the first substance for detection is bound to the target substance, while aggregating the magnetic fine particles so as to form an aggregate in the solution; (4) introducing the solution containing the aggregate of the magnetic fine particles onto the magnetic sensor layer; (5) applying a magnetic field with a magnetic gradient in a direction perpendicular to the surface of the magnetic sensor layer to the solution containing the aggregate of the magnetic fine particles, whereby the target substance bound with the magnetic fine particle constituting the aggregate is bound to the second substance for detection so as to immobilize the aggregate of the magnetic fine particles onto the surface of the magnetic sensor layer; and (6) measuring a magnetic stray field of the aggregate of the magnetic fine particles immobilized in the step (5) using a magnetic sensor constituting the magnetic sensor layer so as to detect the target substance.

2. The method for biochemical analysis according to 1, wherein the step (3) comprises:

applying a magnetic field of which polar of the gradient alters with time to the solution containing the magnetic fine particles and the target substance, whereby the magnetic fine particles are aggregated so as to form an aggregate in the solution.

3. The method for biochemical analysis according to 1, wherein the step (3) comprises:

(i) applying a magnetic field of which polar of the gradient alters with time to the solution containing the magnetic fine particles and the target substance, whereby the first substance for detection is bound to the target substance; and

(ii) applying magnetic fields stronger than those in the step (i) and the magnetic fields with the polar of the gradient which alters with time, whereby the magnetic fine particles are aggregated so as to form an aggregate in the solution.

4. The method for biochemical analysis according to any one of 1 to 3, wherein the magnetic sensor constituting the magnetic sensor layer is selected from the group consisting of a Hall sensor and a magnetoresistance effect-based sensor.

Further features of the present invention will become apparent from the following description of exemplary embodiments with reference to the attached drawings.

### BRIEF DESCRIPTION OF THE DRAWINGS

FIGS. 1A, 1B, 1C and 1D are respectively a diagram schematically illustrating each step of a method for biochemical analysis of an embodiment 1.

FIGS. 2A, 2B and 2C are respectively a flow chart illustrating one example of procedures for measuring a target substance according to the present invention.

FIGS. 3A, 3B and 3C are respectively a diagram schematically illustrating each step of a conventional method for biochemical analysis.

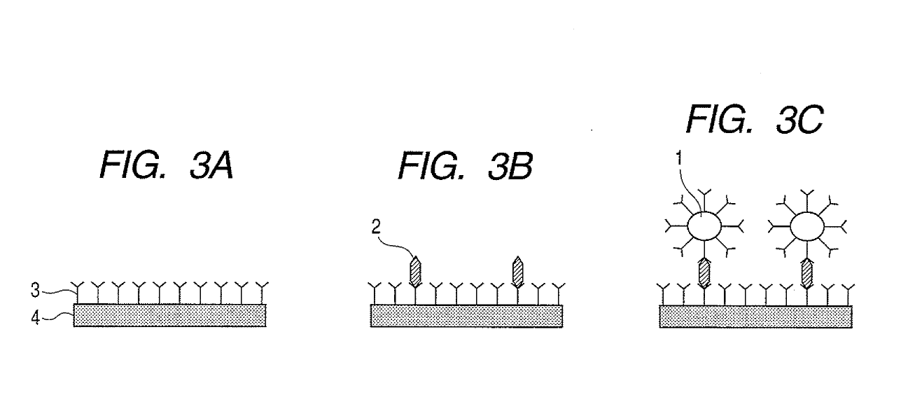

FIGS. 4A, 4B, and 4C are respectively a flow chart illustrating procedures for measuring a target substance according to a conventional method and the present invention.

FIG. 5 is a diagram schematically illustrating each step of a method for biochemical analysis of an embodiment 2.

FIGS. 6A, 6B and 6C are respectively a diagram schematically illustrating each step of a method for biochemical analysis of an embodiment 3.

FIG. 7 is a diagram schematically illustrating each step of a method for biochemical analysis of an embodiment 4.

### DESCRIPTION OF THE EMBODIMENTS

Method for Biochemical Analysis

A method for biochemical analysis of the present invention includes:

(1) preparing magnetic fine particles having a surface on which a first substance for detection capable of binding to a target substance is immobilized;

(2) preparing a magnetic sensor layer having a surface on which a second substance for detection capable of binding to the target substance is immobilized;

(3) adding the magnetic fine particles into a solution containing the target substance, whereby the first substance for detection is bound to the target substance, while aggregating the magnetic fine particles so as to form an aggregate in the solution;

(4) introducing the solution containing the aggregate of the magnetic fine particles onto the magnetic sensor layer;

(5) applying a magnetic field with a magnetic gradient in a direction perpendicular to the surface of the magnetic sensor layer to the solution containing the aggregate, whereby the target substance bound with the magnetic fine particle constituting the aggregate is bound to the second substance for detection so as to immobilize the aggregate onto the surface of the magnetic sensor layer; and

(6) measuring a magnetic stray field of the aggregate immobilized in the step (5) using a magnetic sensor constituting the magnetic sensor layer so as to detect the target substance.

In the present invention, in the step (1), magnetic fine particles having a surface on which a first substance for detection capable of binding to a target substance is immobilized are first prepared.

Next, in the step (2), a magnetic sensor layer having a surface on which a second substance for detection capable of binding to the target substance is immobilized is prepared. Examples of this magnetic sensor layer can include a magnetic sensor layer formed as the whole or a portion of the inner wall of a container. In this case, the second substance for detection faces the inner wall side of this magnetic sensor layer.

In this context, the first substance for detection and the second substance for detection may be the same or different as long as the first substance for detection and the second substance for detection are capable of binding to the target substance. To form stable binding with the target substance, the first substance for detection and the second substance for detection can be the same. In the analysis of plural types of target substances by the method of the present invention, plural types of first substances for detection and plural types of second substances for detection corresponding thereto are used.

In the present invention, next, in the step (3), the first substance for detection immobilized on the surface of the magnetic fine particle is specifically bound to the target substance in a solution. This reaction is liquid phase-liquid phase reaction. The collision frequency of molecules (the first substance for detection immobilized on the magnetic fine particles and the target substance) is high. As a result, reaction efficiency can be enhanced.

This step (3) includes (a) performing the binding reaction between the first substance for detection immobilized on the surface of the magnetic fine particle and the target substance, while (b) aggregating the magnetic fine particles so as to form an aggregate. The reactions (a) and (b) may occur simultaneously. Alternatively, the reaction (a) may occur before the reaction (b). To efficiently perform each of the reactions (a) and (b), the reaction (a) can occur before the reaction (b).

In the reaction (b), this aggregation of the magnetic fine particles is performed by binding between the magnetic fine particles via the target substance. Thus, the object to be measured has relatively large magnetization such that they can move easily by application of magnetic field.

Next, in the step (4), the solution containing the aggregate of the magnetic fine particles is introduced onto the magnetic sensor layer. In this context, the term “introduce” means bringing the solution containing the aggregate of the magnetic fine particles into contact with the magnetic sensor layer surface (second substance for detection). For example, in the example described above, the solution containing the aggregate of the magnetic fine particles can be injected into the container having the magnetic sensor layer formed as the whole or a portion of the inner wall thereof so as to bring the solution into contact with the magnetic sensor layer surface (second substance for detection).

The term “introduce” also means bringing in advance the magnetic sensor layer surface (second substance for detection) into contact with the solution containing the target substance and next adding the magnetic fine particles into the solution so as to form an aggregate. Specifically, the term “introduce” described herein means causing aggregation reaction on the magnetic sensor layer or injecting the solution containing the aggregate of the magnetic fine particles so as to permit the contact between the magnetic sensor layer surface and the aggregate.

Next, in the step (5), a magnetic field with a magnetic gradient is applied in a direction perpendicular to the surface of the magnetic sensor layer to the solution containing the aggregate. The magnetic aggregate in the solution can be moved efficiently to the magnetic sensor layer side by this action. Specifically, in the absence of the action of such a magnetic field, the aggregate in the solution is moved only by diffusion based on a concentration gradient and Brownian motion. However, this diffusion velocity is low, and efficient reaction is difficult to perform. By contrast, in the presence of the application of a magnetic field to the solution as in the present invention, magnetic force derived from this magnetic field can act on the magnetic fine particles so as to efficiently move the magnetic fine particles to the magnetic sensor layer side.

Furthermore, the target substance bound with the magnetic fine particle constituting the aggregate thus moved to the magnetic sensor layer side is bound to the second substance for detection so as to immobilize the aggregate onto the surface of the magnetic sensor layer. Specifically, the aggregate is bound with the magnetic sensor layer via the binding among the first substance for detection, the target substance and the second substance for detection. The reaction for this immobilization is not limited to antigen-antibody reaction and however, must be chemical reaction that causes the binding between the target substance bound with the first substance for detection on the surface of the magnetic fine particle and the second substance for detection on the magnetic sensor layer.

Then, in the step (6), a magnetic stray field of the aggregate immobilized in the step (5) is measured using a magnetic sensor constituting the magnetic sensor layer. As a result, the target substance immobilized on the substrate is quantified and detected. In the detection of plural types of target substances, the method of the present invention can be applied using plural first substances for detection and plural second substances for detection respectively capable of specifically binding to the target substances. As a result, which type of second substance for detection has achieved the immobilization of the magnetic fine particle having the corresponding target substance or has not achieved such immobilization can be analyzed individually using the magnetic sensor below each second substance for detection.

Next, the principle of measurement of a magnetic stray field will be described by taking, as an example, a GMR sensor used as a magnetic sensor. A GMR sensor basically has a sandwich structure in which a nonmagnetic layer is sandwiched between two magnetic layers. In a GMR sensor, plural magnetic sensors are provided in one magnetic layer. An external magnetic field is detected depending on the relative magnetization directions (parallel/antiparallel) of these two magnetic layers. Specifically, in a GMR sensor having an aggregate-immobilized surface, the magnetization of magnetic layers constituting the GMR sensor is inverted by the influence of the magnetic field of this aggregate. By contrast, in a GMR sensor having a surface free of an aggregate immobilized thereon, the magnetization of magnetic layers constituting the GMR sensor is not inverted. For all the magnetic sensors, a rate of change in the direction of this magnetization is detected as a magnetoresistance effect curve. The magnetoresistance effect curve thus obtained can be compared with, as a reference, a magnetoresistance effect curve of the GMR sensor having a surface free of an aggregate immobilized thereon so as to measure the amount of change in this magnetoresistance effect curve. This measurement of the amount of change permits the quantitative measurement of a target substance.

The GMR sensor has the following advantages as a magnetic sensor:

immobilized magnetic fine particles can be positioned very close to a magnetic sensor so as to detect a magnetic stray field thereof with supersensitivity;
a primary antibody-immobilized magnetic sensor can be prepared as an array using a micromachining process, and different substances to be detected can be measured simultaneously (multiple measurement); and
a sensor module can be made compact.

Hereinafter, one example of the method for biochemical analysis of the present invention will be described in detail by taking antigen-antibody reaction as an example.

First, a magnetic sensor layer having a surface coated with a primary antibody as a second substance for detection (or a magnetic sensor layer having a surface on which a primary antibody as a second substance for detection is immobilized) is formed on a substrate (step (2)). Next, magnetic fine particle surfaces are coated with a secondary antibody (first substance for detection) (or a secondary antibody (first substance for detection) is immobilized onto magnetic fine particle surfaces) (step (1)). Furthermore, the secondary antibody-coated magnetic fine particles are mixed into a solution containing an antigen as a target substance. In this procedure, the secondary antibody on the surface of the magnetic fine particle causes specific binding reaction with the target substance so as to immobilize the target substance onto the surface of the magnetic fine particle. In this case, the magnetic fine particles can have superparamagnetic properties and have magnetization properties appropriate for an external magnetic field.

Subsequently, a magnetic field is applied to the solution so as to form an aggregate of the magnetic fine particles (step (3)). Next, the solution containing the aggregate of the magnetic fine particles is introduced onto the magnetic sensor layer (step (4)). Then, a magnetic field with a magnetic gradient is applied in a direction perpendicular to the surface of the magnetic sensor layer to the solution containing the aggregate, whereby the magnetic fine particles are attracted to the magnetic sensor layer side. Then, the magnetic fine particles are immobilized on the primary antibody on the surface of the magnetic sensor layer via the target substance immobilized on the surface of the magnetic fine particle (step (5)). Next, a magnetic stray field of the magnetic fine particles immobilized on the surface of the magnetic sensor layer can be detected using a magnetic sensor constituting the magnetic sensor layer so as to quantify and detect the target substance (step (6)). In the quantitative analysis of a trace amount of a target substance, an absolute calibration curve method can be used.

(Effects)

Hereinafter, the effects of the present invention compared with conventional analysis methods will be described.

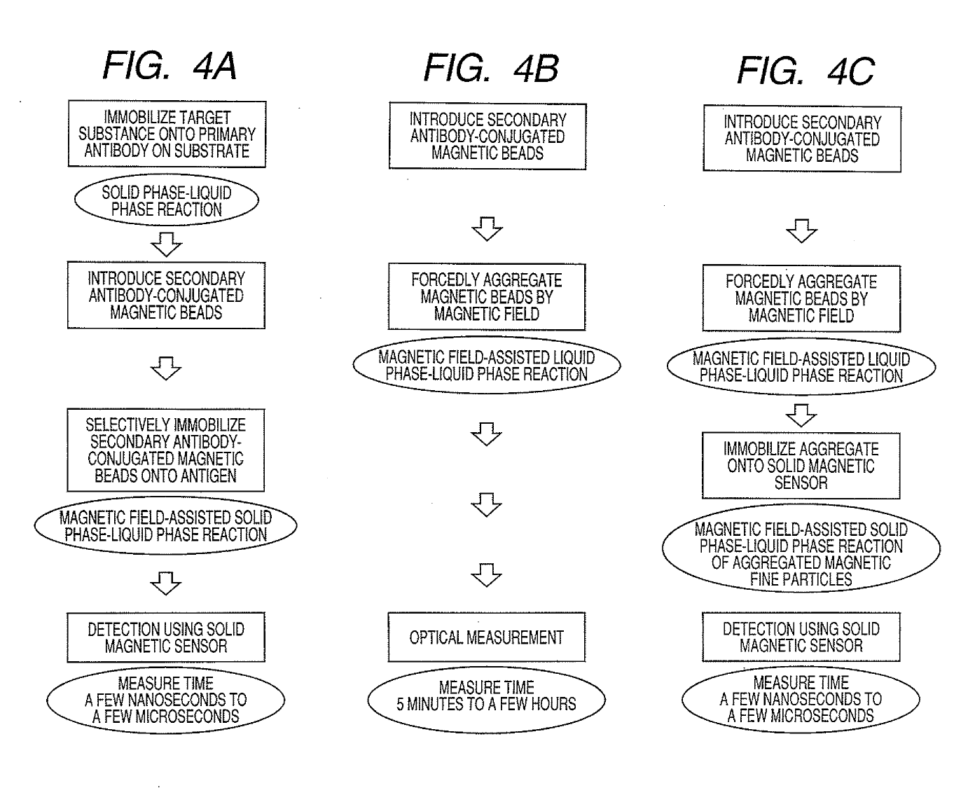

In this context, FIG. 4A illustrates a flow chart of procedures for measuring a target substance by the method for detecting magnetic fine particles using a GMR sensor (the method for magnetically detecting magnetic fine particles (3)). FIG. 4B illustrates a flow chart of procedures for measuring a target substance by the optical detection method using magnetic fine particles (the method for optically detecting an aggregate of magnetic fine particles (2)). FIG. 4C illustrates a flow chart of procedures for measuring a target substance by the detection method of the present invention. Each of the detection methods illustrated in FIGS. 4A to 4C will be evaluated for (i) sensitivity, (ii) quickness and (iii) a compact size of an apparatus, as described below.

(i) Sensitivity

The detection method of (1) and (2) are based on the optical change. The change in optical characteristics is required to occur throughout the whole solution. The detection limit of (1) and (2) is a several μg/ml to a several tens mg/ml when the target substance is IgG although the limit may be different depending on the kind of the target substance. On the other hand, the detection methods of (3) and the present invention do not require a change throughout a whole solution. They can detect a single to several magnetic fine particles immobilized on the sensor. Therefore, the sensitivity is higher than the method of (1) and (2).

(ii) Quickness

Of the methods (1) to (3), the optical detection method (2) including liquid phase-liquid phase reaction as main reaction can achieve the quickest measurement. Thus, the method (2) will be compared with the method of the present invention. The detection method of the present invention includes two stages: forming an aggregate of the target substance-immobilized magnetic fine particles; and immobilizing this aggregate onto the magnetic sensor layer. Therefore, the number of steps is large. However, the reaction for immobilizing the aggregate at the second stage can be performed at high reaction velocity (in a shortened reaction time). Moreover, the measurement using a magnetic sensor is also fast-responsive measurement. Therefore, such measurement can be performed for a time much shorter than that of optical measurement. As a result, the analysis method of the present invention can be as quick as the optical detection method (2) in terms of an analysis time, as a whole.

(iii) Compact Size of Apparatus

The magnetic detection method (3) capable of micromachining using a semiconductor lithography process and the detection method of the present invention are excellent in the compact size of an apparatus.

Thus, it is shown that only the analysis method of the present invention simultaneously satisfies (i) sensitivity, (ii) quickness and (iii) a compact size of an apparatus. Moreover, it is shown that the method of the present invention has remarkable effects by a synergistic effect, beyond the combined effect of increase in the size of magnetic fine particles attributed to the aggregation thereof with the effect of a highly sensitive magnetic sensor.

In the step (3) of the present invention, weak magnetic fields that do not cause the magneto static coupling between the magnetic fine particles colliding with each other by their magnetization are applied to the solution so as to stir the magnetic fine particles. As a result, the collision probability between the magnetic fine particle and the target substance can be improved without aggregating the magnetic fine particles.

Subsequently, magnetic field strong enough to form an aggregate between the magnetic fine particles colliding with each other by magneto static coupling and the magnetic field having magnetic gradient is applied. Further, the polar of the magnetic gradient is changed with time so that the magnetic force in opposite direction is applied to the magnetic particle alternately. As a result, the collision frequency of magnetic fine particles are increased by stirring them in the solution and magnetic fine particles aggregates in shorter time.

The step (3) of the present invention can include:

(i) applying a magnetic field of which polar of the gradient alters with time to the solution containing the magnetic fine particles and the target substance, whereby the first substance for detection is bound to the target substance; and

(ii) applying magnetic fields stronger than those in the step (i) and the magnetic fields with the polar of the gradient which alter with time, whereby the magnetic fine particles are aggregated so as to form an aggregate in the solution.

The strength of the magneto static coupling acting on the magnetic fine particles depends on the strength of the magnetization and the distance between magnetic fine particles. The strength of magneto static coupling of the magnetic fine particles in the present invention is adjusted by controlling the magnetic characteristics of their material or the thickness of the polymer coating constituting their surface layer. The thickness of the polymer coating is adjusted so that magneto static coupling strong enough to form aggregation occurs when strong magnetic field is applied while aggregation is not formed when weak magnetic field is applied.

The magnetic fine particles of the present invention are preferably superparamagnetic because they should not form aggregation during the reaction of the magnetic fine particles and the target substance or in non-magnetic field. When a strong magnetic field is applied to the solution, the magnetic fine particles gain strong magnetization. Thus, strong magneto static coupling is caused by collision of magnetic fine particles and magnetic fine particles aggregate easily. On the other hand, when a weak magnetic field is applied to the solution, the magnetic fine particles gain weak magnetization. Thus, weak magneto static coupling is caused by collision of magnetic fine particles, and magnetic fine particles less aggregate.

In the step (i), a weak magnetic field with the polar of the gradient which alters with time is applied to the magnetic fine particles adjusted as above. The magnetic fine particles are stirred by such application of the magnetic field, thus the collision frequency of antigens and the magnetic fine particles increases. As a result, a large amount of the antigen can be bound to the surface of the magnetic fine particles.

Next, in the step (ii) magnetic fields stronger than those in the step (i) and the magnetic fields with the polar of the gradient which alters with time is applied to the solution containing the target substance and the magnetic fine particles. As a result, the magnetic fine particles having a surface to which the target substance (antigen) is attached can be allowed to collide with each other with high probability. In this procedure, the first substance for detection bound with the target substance through antigen-antibody reaction in the step (i) and the target substance-unbound first substance for detection are present on the surface of the magnetic fine particle. Thus, during the collision between the magnetic fine particles, antigen-antibody reaction occurs between the target substance bound with the first substance for detection immobilized on one magnetic fine particle and the target substance-unbound first substance for detection immobilized on the other magnetic fine particle. As a result, the magnetic fine particles can be aggregated easily by binding through antigen-antibody reaction so as to form an aggregate.

Hereinafter, each material used in the method for biochemical analysis of the present invention will be described.

(Magnetic Fine Particles and First Substance for Detection)

The magnetic fine particles of the present invention satisfy the following conditions: they can move by application of magnetic field; and they can be detected by magnetic sensor. For example, polymer beads of a few dozens of nm or larger and a few μm or smaller in particle size incorporating therein uniformly distributed fine crystals of iron oxide components can be used as these magnetic fine particles. Alternatively, in addition to iron oxide, fine crystals of transition metals such as Fe, Ni and Co can be used. Magnetic fine particles of these magnetic metals can have superparamagnetic properties.

The magnetic fine particles of the present invention are coated with a substance having a binding site for chemical binding with a variety of first substances for detection such that the first substances for detection are immobilized on the surfaces of the magnetic fine particles. The coating of such a substance permits, for example, the immobilization of the following first substances for detection onto the surface of the magnetic fine particle:

single-stranded or double-stranded full-length or fragmented nucleotides, peptides, proteins, lipids, low-molecular-weight compounds, sugars, liposomes, antibodies and other biological materials; and antigens or antibodies.

An antigen or antibody may be used as a first substance for detection. When an antigen is used as a first substance for detection, an antibody is used as a target substance. Alternatively, when an antibody is used as a first substance for detection, an antigen is used as a target substance.

The aggregate of the magnetic fine particles of the present invention is a complex formed by the binding between plural magnetic fine particles having a surface on which the first substance for detection is immobilized. This binding is formed via the specific binding between the first substance for detection and the target substance. Examples of the process for forming such binding between the magnetic fine particles can include the following two processes:

(a) a process in which the first substance for detection on the surface of the magnetic fine particle collides with the target substance so as to cause the specific binding between the first substance for detection and the target substance; and
(b) a process in which the magnetic fine particles bound with the target substance collide with each other so as to cause the specific binding between the target substance-unbound first substance for detection bound with one magnetic fine particle and the target substance bound with the first substance for detection bound with the other magnetic fine particle.

The processes (a) and (b) may occur simultaneously. Alternatively, the process (a) may occur before the process (b). The simultaneous or separate occurrence of the processes (a) and (b) is largely influenced by the composition of the solution containing the target substance and the magnetic fine particles and conditions for applying a magnetic field to the solution.

In the detection of plural target substances by the method of the present invention, plural types of magnetic fine particles on which a first substance for detection different from those on the other magnetic fine particles is immobilized are used. In this context, the term “different” means that the first substance for detection immobilized on each magnetic fine particle is capable of specifically binding to a target substance different from those of the other magnetic fine particles.

(Second Substance for Detection)

The second substance for detection is a substance capable of specifically binding to the target substance. Examples of the second substance for detection that can be used include the followings:

Single-stranded or double-stranded full-length or fragmented nucleotides, peptides, proteins, lipids, low-molecular-weight compounds, sugars, liposomes, antibodies and other biological materials; and
antigens or antibodies.

An antigen or antibody may be used as a second substance for detection. When an antigen is used as a second substance for detection, an antibody is used as a target substance. Alternatively, when an antibody is used as a second substance for detection, an antigen is used as a target substance.

The second substance for detection and the first substance for detection may be the same or different. The second substance for detection can be the same as the first substance for detection.

(Substrate)

The magnetic sensor layer of the present invention can be provided on a substrate. The substrate is not particularly limited as long as the substrate permits the placement of the magnetic sensor layer thereon and does not influence the operation and precision of a magnetic sensor. A silicon substrate or compound semiconductor substrate used in a semiconductor process as well as a substrate mainly including glass or resin (e.g., polycarbonate) substrate may be used.

(Solution and Target Substance)

In the present invention, examples of the solution containing the target substance can include: body fluids such as blood and urine; and mixtures of these body fluids with buffer solutions. In this case, examples of the target substance to be detected can include antigens and other biochemical substances.

(Magnetic Sensor)

In the present invention, the magnetic sensor can be selected from the group consisting of a Hall sensor and a magnetoresistance effect-based sensor. Specifically, the magnetic sensor can be selected from the group consisting of a GMR sensor and a TMR sensor.

Hereinafter, embodiments of a method for biochemical analysis using antigen-antibody reaction as specific binding and a GMR sensor as a magnetic sensor will be described.

### Embodiment 1

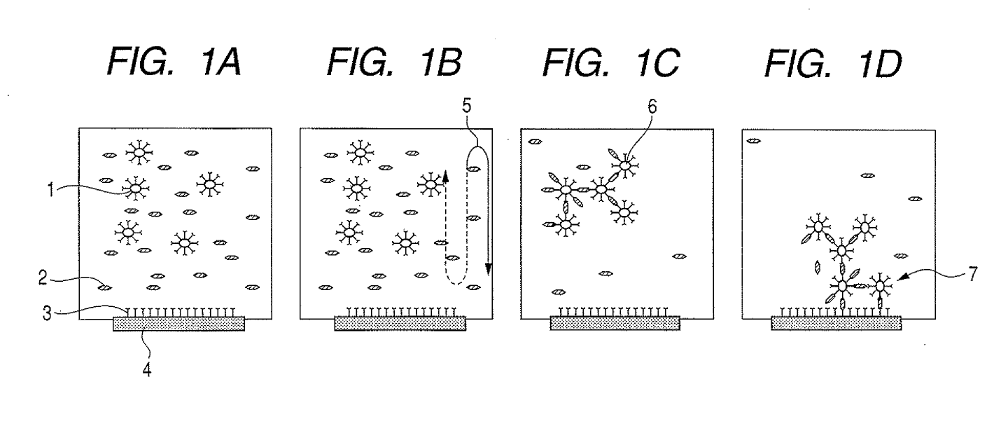

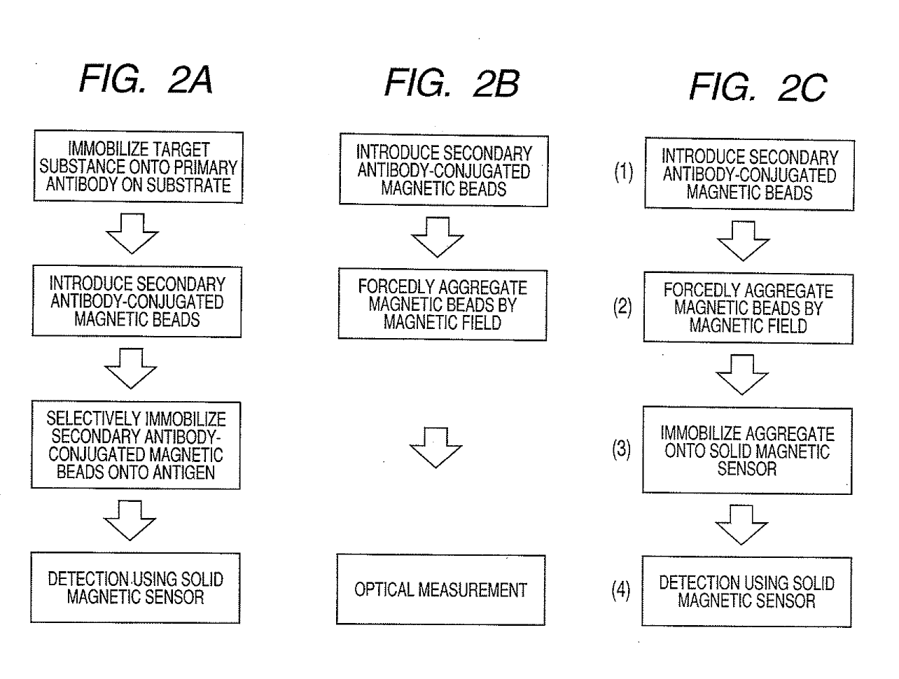

FIGS. 2C(1) to 2C(4) illustrate a flow chart of procedures for measuring a target substance according to an embodiment 1. FIGS. 1A to 1D are respectively a diagram schematically illustrating each step of the method of the embodiment 1.

First, as illustrated in FIG. 2C(1), secondary antibody (first substance for detection)—conjugated magnetic fine particles 1 are prepared and introduced into a solution containing an antigen 2. FIG. 1A illustrates this state, wherein magnetic fine particles on which a first substance for detection capable of specifically binding to a target substance is immobilized are introduced in a solution containing the target substance. Examples of this solution containing the target substance can include: body fluids such as blood and urine; and mixtures of these body fluids with buffer solutions.

A membrane (e.g., Au) capable of easily immobilizing biomolecules thereon is formed on a GMR sensor layer (magnetic sensor layer) 4 in FIG. 1A. The whole surface of the Au membrane is further coated with a primary antibody (second substance for detection) 3 capable of specifically binding to the target substance. FIGS. 1B to 1D illustrate one example 5 of movement of the aggregated magnetic particles by the action of the magnetic fields with a gradient, aggregated magnetic particles 6 and immobilization 7 of the aggregated magnetic particles on the magnetic sensor formed on the substrate.

Next, as illustrated in FIG. 2C(2), (FIG. 1B). Magnetic field with the polar of the gradient which alters with time is applied to the solution. Magnetic fine particles move in the solution according to the gradient of the magnetic field. If the antigen as the target substance exists in the solution, the collision frequency between the particle and the target substance increases and plural magnetic fine particles aggregate more easily via antigen-antibody reaction. Finally aggregate of fine particles is formed (FIG. 1C). In this procedure, if the solution contains no target substance, no aggregate of the magnetic fine particles through antigen-antibody reaction occurs.

Next, as illustrated in FIG. 2C(3), magnetic fields are applied, whereby this aggregate of the magnetic fine particles is attracted to the surface of the magnetic sensor layer. In this procedure, a binding site in the target substance specifically bound with the surface of the magnetic fine particle constituting the aggregate is specifically bound to the primary antibody (second substance for detection) on the magnetic sensor layer (FIG. 1D). After this procedure, the aggregate of the magnetic fine particles unimmobilized on the surface of the magnetic sensor layer is removed by washing.

Next, as illustrated in FIG. 2C(4), the magnetic properties of the reaction system including the thus-immobilized aggregate of the magnetic fine particles are measured. In this procedure, if the aggregate of the magnetic fine particles is immobilized on the GMR sensor, the GMR sensor detects a magnetic stray field of the aggregate of the magnetic fine particles, producing a change in magnetoresistance effect curve (not shown). Thus, the aggregate of the magnetic fine particles can be detected by measuring a magnetoresistance effect curve using the GMR sensor.

The aggregate of the magnetic fine particles may be detected based on a change in magnetoresistance effect curve, as described above. In such a case, a sample that does not produce such an aggregate of the magnetic fine particles can be used in advance as a reference. The amount of change in the signal of the GMR sensor, that is, a change in magnetoresistance effect curve, can be measured based on this reference. For example, the sample may be mixed with a buffer solution. In such as case, the buffer solution can be used as a reference. Before actual measurement, plural measurements using a similar sample are performed for creating a calibration curve, and measurement can then be performed actually. Such creation of a calibration curve permits more accurate measurement capable of detecting a trace amount of a target substance.

### Embodiment 2

In the present embodiment, a quicker method obtained by expanding the method of the embodiment 1 will be described.

Specifically, in a step corresponding to FIG. 2C(2) of the embodiment 1, magnetic fields having a magnetic gradient may be applied in any direction and by any method to the solution containing the target substance and the magnetic fine particles.

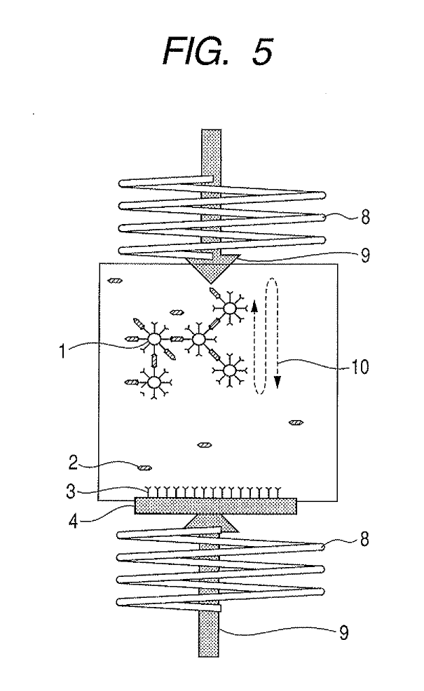

Thus, in the present embodiment, as illustrated in FIG. 5, electromagnets are arranged above and below the solution so as to alternately generate magnetic fields above and below the solution. Thus, the gradient of the magnetic field is inverted with high frequency in the solution. As a result, the effect of stirring the magnetic fine particles can be enhanced so as to enhance the collision frequency between the magnetic fine particles. Moreover, aggregation reaction velocity between the magnetic fine particles can be enhanced so as to shorten a process time. FIG. 5 also illustrates a magnet (electromagnet or permanent magnet) 8 to apply magnetic fields, alternate action 9 of magnetic fields with a gradient in a direction perpendicular to the substrate on the container, and one example 10 of movement of the aggregated magnetic particles by applying the magnetic fields with a gradient on the container.

### Embodiment 3

In the present embodiment, a further quicker method obtained by expanding the methods of the embodiments 1 and 2 will be described.

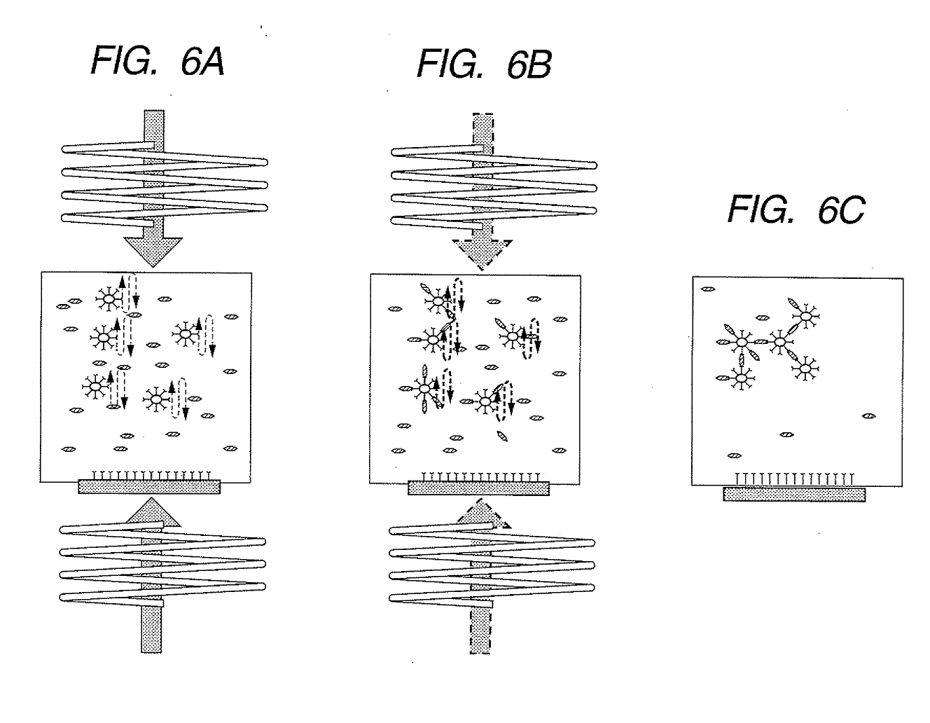

In the present embodiment, in a step corresponding to FIG. 2C(2) of the embodiment 1, two stages are performed. Specifically, this step includes: (i) applying weak magnetic fields to a solution illustrated in FIG. 6A, whereby magnetic fine particles are bound to an antigen; and (ii) applying strong magnetic fields to a solution illustrated in FIG. 6B, whereby the magnetic fine particles bound with the antigen are aggregated. Then, an aggregate of the magnetic fine particles is finally formed, as illustrated in FIG. 6C.

Specifically, in the present embodiment, the binding between the magnetic fine particles in the formation of an aggregate of the magnetic fine particles is formed only by antigen-antibody reaction. In this case, binding attributed to magnetic coupling or natural aggregation is hardly formed. Moreover, such formation of an aggregate of the magnetic fine particles at two stages permits the highly sensitive detection of a trace amount of an antigen.

To perform such two stages, the magnetic fine particles must be magnetized according to the strength of a magnetic field acting thereon. Specifically, the magnetic fine particles must be adjusted as follows:

(A) the control of the magnetic susceptibility of the magnetic fine particles and the control of the strength of a magnetic field applying to the solution; and
(B) the control of the film thickness of polymer coating on the magnetic fine particle surface and the control of the strength of a magnetic field applying to the solution.

The adjustments (A) and (B) will be described in more detail.

In the adjustment (A), the magnetic force generated between the magnetic fine particles in the step (ii) is made stronger than the dispersion force (electrostatic repulsion, force that pulls off the magnetic fine particles by a trace flow in the solution, etc.) of the magnetic fine particles. Whether or not the magnetic fine particles are adjusted as in (A) can be confirmed by placing magnetic fine particles incorporating magnetic substances having magnetic properties different from each other in magnetic fields having different strengths at stages and observing the dispersibility of the magnetic fine particles after stirring.

In the adjustment (B), the distance between the magnetic fine particles located in vicinity to each other is adjusted by the steric hindrance effect of polymer coating on the magnetic fine particle surface. Such adjustment of the distance between the magnetic fine particles permits the control of the magnetic force generated between the magnetic fine particles according to the strength of a magnetic field applying to the solution in the steps (i) and (ii). Whether or not the magnetic fine particles are adjusted as in (B) can be confirmed by placing magnetic fine particles having different polymer film thicknesses in magnetic fields having different strengths at stages and observing the dispersibility of the magnetic fine particles after stirring.

The magnetic fine particles can be adjusted as in (A) or (B) and stirred at these two stages so as to cause specific biomolecule reaction with higher reaction efficiency and a lower noise.

### Embodiment 4

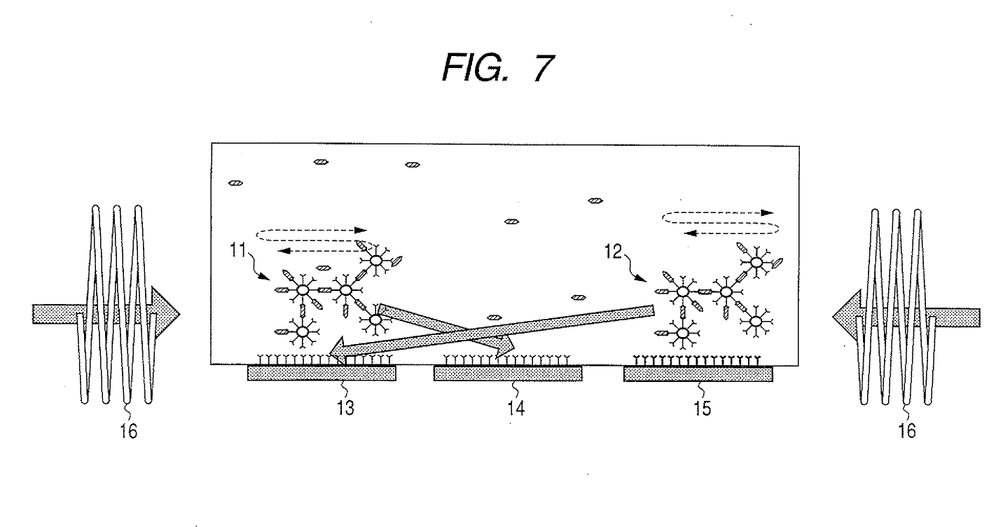

In the present embodiment, a method capable of measuring the contents of plural types of target substances by further expanding the methods of the embodiments 1, 2 and 3 will be described. FIG. 7 is a schematic diagram illustrating the method for detecting plural types of target substances according to the present embodiment. In the present embodiment, two types of target substances and two types of magnetic fine particles corresponding thereto are present in a solution.

In the present embodiment, a process for immobilizing the target substances onto the magnetic fine particle surfaces in the solution and a process for forming an aggregate of the magnetic fine particles after immobilization are performed in the same way as in the embodiment 1. Moreover, plural GMR sensors constituting magnetic sensor layers are formed on a substrate in the bottom of a container. Antibodies (second substances for detection) corresponding to the two types of target substances are formed on the GMR sensor surfaces. These antibodies are capable of specifically binding to their respective corresponding target substances. FIG. 7 also illustrates first aggregated magnetic fine particles 11, second aggregated magnetic fine particles 12, a first magnetic sensor 13, and a second magnetic sensor 14, a third magnetic sensor 15 and a magnet 16 for applying a magnetic field in a direction parallel to the substrate. The first aggregated magnetic fine particles 11 specifically bind to the primary antibody on the second GMR element 14. The second aggregated magnetic fine particles 12 specifically bind to the primary antibody on the first GMR element 13.

The aggregate of the magnetic fine particles is formed in the same way as in the embodiment 1. Then, applying a magnetic field with a magnetic gradient in a direction perpendicular to the surface of the magnetic sensor layer, wherein the magnetic field is strongest in surface adjacent, whereby the aggregate of the magnetic fine particles is attracted to the GMR sensor side.

Next, a magnetic stray field of the aggregate of the magnetic fine particles is measured using the GMR sensor. In this procedure, the particular second substance for detection is immobilized on the particular GMR sensor within the magnetic sensor layer. Therefore, which aggregate of the magnetic fine particles has been immobilized can be determined by measuring a change in the signal of each GMR sensor attributed to the magnetic stray field. In this way, plural types of target substances can be detected.

The method for biochemical analysis of the present invention is applicable to chemical or medical fields and is particularly applicable to clinical fields. More specifically, the method for biochemical analysis of the present invention can be utilized analysis such as gene mutation analysis, gene expression analysis, polymorphism analysis, kinetic analysis on intermolecular reaction and analysis on antigen-antibody reaction or hormone response.

The use of the method for biochemical analysis according to the exemplary aspects of the present invention described above can shorten a process time from the introduction of a target substance and magnetic fine particles into an analysis system to signal detection. Moreover, the use of the method for biochemical analysis of the present invention achieves supersensitive, quick and accurate biochemical analysis and may make a biochemical analysis apparatus compact.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-154992, filed Jun. 12, 2007, which is hereby incorporated by reference herein in its entirety.

What is claimed is:

1. A method for biochemical analysis comprising:
(1) preparing magnetic fine particles having a surface on which a first substance for detection capable of binding to a target substance is immobilized;
(2) preparing a magnetic sensor layer having a surface on which a second substance for detection capable of binding to the target substance is immobilized;
(3) adding the magnetic fine particles into a solution containing the target substance, whereby the first substance for detection is bound to the target substance, while aggregating the magnetic fine particles so as to form an aggregate in the solution;
(4) introducing the solution containing the aggregate of the magnetic fine particles onto the magnetic sensor layer;
(5) applying a magnetic field with a magnetic gradient in a direction perpendicular to the surface of the magnetic sensor layer to the solution containing the aggregate of the magnetic fine particles, whereby the target substance bound with the magnetic fine particle constituting the aggregate is bound to the second substance for detection so as to immobilize the aggregate of the magnetic fine particles onto the surface of the magnetic sensor layer; and
(6) measuring a magnetic stray field of the aggregate of the magnetic fine particles immobilized in the step (5) using a magnetic sensor constituting the magnetic sensor layer so as to detect the target substance.

2. The method for biochemical analysis according to claim 1, wherein the step (3) comprises:
applying a magnetic field of which polar of the gradient alters with time to the solution containing the magnetic fine particles and the target substance, whereby the magnetic fine particles are aggregated so as to form an aggregate in the solution.

3. The method for biochemical analysis according to claim 1, wherein the step (3) comprises:
(i) applying a magnetic field of which polar of the gradient alters with time to the solution containing the magnetic fine particles and the target substance, whereby the first substance for detection is bound to the target substance; and
(ii) applying magnetic fields stronger than those in the step (i) and the magnetic fields with the polar of the gradient which alters with time, whereby the magnetic fine particles are aggregated so as to form an aggregate in the solution.

4. The method for biochemical analysis according to claim 1, wherein the magnetic sensor constituting the magnetic sensor layer is selected from the group consisting of a Hall sensor and a magnetoresistance effect-based sensor.
